(19) United States
(12) Patent Application Publication
(10) Pub. No.: US 2014/0068738 A1
(43) Pub. Date: Mar. 6, 2014

(54) ADAPTIVE DEVICE AUTHENTICATION

(71) Applicant: NetAuthority, Inc., Fremont, CA (US)

(72) Inventors: Talbot HARTY, Sutter Creek, CA (US); Dono HARJANTO, Irvine, CA (US); Karim KADDOURA, San Francisco, CA (US)

(21) Appl. No.: 13/923,123

(22) Filed: Jun. 20, 2013

Related U.S. Application Data
(60) Provisional application No. 61/694,612, filed on Aug. 29, 2012.

(30) Foreign Application Priority Data
Oct. 18, 2012 (AU) 2012101558

(51) Int. Cl. G06F 21/44

(52) U.S. Cl. CPC G06F 21/44
USPC 726/7

(57) ABSTRACT

Device attributes corresponding to hardware and system configuration and characteristics of the user of the device are associated with adjustment logic, e.g., according to various types and classes of attributes. A hierarchical authentication process provides highly detailed and accurate authentication of a device, including device identification, device authentication, user authentication, and attribute adjustment. If the device is not properly identified, authentication fails. Otherwise, device authentication is attempted. If device authentication fails, all authentication fails. Otherwise, the user of the device is authenticated. If user authentication fails, authentication of the device fails. Otherwise, adjustment logic is used to adjust attributes for subsequent authentication.

This application is related to U.S. Provisional Application 61/694,612, which was filed on Aug. 29, 2012 and which is fully incorporated herein by reference.

### BACKGROUND OF THE INVENTION

1. Field of the Invention

The present invention relates generally to computer systems and, more particularly, to methods of and systems for uniquely identifying computing devices.

2. Description of the Related Art

Device identification through digital fingerprints, i.e., though a collection of hardware and system configuration attributes, has proven to be invaluable in recent years to such technologies as security and digital rights management. In security, authentication of a person can be restricted to a limited number of previously authorized devices that are recognized by their digital fingerprints. In digital rights management, use of copyrighted or otherwise proprietary subject matter can be similarly restricted to a limited number of previously authorized devices that are recognized by their digital fingerprints.

To facilitate device recognition over time, it is generally preferred to construct a device fingerprint or other globally unique device identifier using hardware and system configuration attributes that are stable, i.e., that do not change over time. However, if a device identifier is static, unscrupulous entities are provided with a new opportunity to crack a device identifier each time the identifier passes through a wide area computer network such as the Internet.

What is needed is a way to uniquely identify individual devices reliably in a manner than makes interception and spoofing the identity of such devices significantly more difficult.

### SUMMARY OF THE INVENTION

In accordance with the present invention, device attributes corresponding to hardware, to system configuration, and to attributes of the user of the device that are dynamic, i.e., that can change over time, are associated with adjustment logic. Thus, interception of a device identifier cannot be effectively used to spoof a different device unless the unscrupulous entity perpetrating the fraud can properly determine which parts of the device identifier are expected to change and in what manner. Such significantly complicates spoofing of device identifiers.

The attributes are associated with adjustment logic, e.g., according to various types and classes of attributes. The adjustment logic determines the manner in which the attributes are adjusted after authentication to facilitate use of attributes that change over time in device authentication.

A device is identified by a dynamic device key (DDK). The DDK is generated by the device in response to a device key challenge sent by a device authentication server. The device key challenge specifies a number of attributes to be included in the DDK, which parts of the attributes are to be included in the DDK if less than the entire attribute, and the manner in which the attributes or parts of attributes are to be combined to form the DDK. That manner can include a specific sequence of attribute parts, including repetition or patterns of one or more attribute parts and bit sampling of attributes.

Since the device key challenge differs with each device authentication transaction, the DDK is different in each such transaction. Accordingly, interception of the DDK, assuming the unscrupulous entity can defeat conventional cryptographic obscuration, cannot be used to successfully spoof the device in a device authentication transaction in which a different device key challenge has been issued. The fact that some attributes from which the DDK is generated are expected to change over time adds an entirely new dimension to the security afforded by the DDK. A hierarchical authentication process provides highly detailed and accurate authentication of a device.

In a first stage, the device authentication server uses the DDK to identify the device as one known to the device authentication server. If the device is not properly identified, authentication fails.

In a second stage, the dynamic device key (DDK) is used to authenticate the device.

The device authentication server parses the attributes or parts of attributes from the received DDK and compares them to corresponding reference attributes in a known device record stored for the identified device. Each of the attributes of the DDK are associated with comparison logic that specifies the manner in which the device authentication server compares the attributes to the corresponding reference attributes and the manner in which the device authentication server determines whether the device is successfully authenticated.

Some attributes are not expected to change over time and can be compared in a simple boolean comparison operation. These attributes lend themselves to comparison of parts of attributes and hash comparisons. Considering a serial number for a hard disk drive as an example, the device key challenge can specify that substrings of the serial number can be included in the DDK at specific locations and hashed, either in isolation or with other static device attributes, for a match/no-match comparison.

Other attributes are expected to change over time and tend to require comparison of the raw data of the whole attribute. For example, a number of bad blocks of a hard disk drive is generally expected to increase or not change. Comparison of only a portion of the number generally does not indicate whether the number has increased, decreased, or remained the same. For this type of attribute, comparison of the raw data of the whole attribute is preferred. Within the DDK, the raw data of the whole attribute can still be obfuscated, e.g., by including a representation of the raw data in text that is hashed in a reversible manner, such that the device authentication server can recover the raw data.

If device authentication at this second stage fails, authentication of the device fails. However, the device authentication server can be configured to send one or more subsequent device key challenges to allow the device subsequent opportunities to be authenticated.

In a third stage, interactive attributes of the dynamic device key (DDK) are used to authenticate the user of the device.

The user is associated with one or more devices. The device key challenge produced by the device authentication server specifies that a number of interactive attributes be included in the DDK. Interactive attributes are those that require information from the user of the device. Such interactive attributes can include knowledge-based authentication (KBA) and biometric attributes. Knowledge-based authentication can be realized using a question-and-answer session with the user, asking for items of information the expected user is expected to know. Biometric attributes can be physical features of the user such as fingerprints, retinal scans, and facial and speech recognition.

The device authentication server parses the interactive attributes or parts of interactive attributes from the received DDK and compares them to corresponding reference interactive attributes in a record stored for the user of the identified device. Each of the interactive attributes of the DDK are associated with comparison logic that specifies the manner in which the device authentication server compares the interactive attributes to the corresponding reference interactive attributes and the manner in which the device authentication server determines whether the user is successfully authenticated.

If user authentication at this third stage fails, authentication of the device fails. However, the device authentication server can be configured to send one or more subsequent device key challenges for interactive attributes to allow the user subsequent opportunities to be authenticated.

If all three stages result in successful authentication, adjustment logic associated with the attributes and interactive attributes causes the device authentication server to adjust attributes or interactive attributes for subsequent authentication. Accordingly, a device and user that change gradually over time will continue to be properly authenticated since difference in hardware, system, and personal characteristics do not accumulate. For example, if a hard disk drive of the device is changed but all other attributes remain consistent, the device can still be authenticate. In such a case, the adjustment logic specifies that attributes associated with the new HDD be updated. In subsequent attempts to authenticate the device, what would have been a mismatch in attributes of the HDD could have accumulated with other changes to the device such that authentication would fail when it should succeed. Other adjustments to attributes including recording changes to attributes that are expected to change over time and using new biometric samples to improve biometric comparison in subsequent authentications.

The result is very rigorous device and user authentication notwithstanding changes to the device and user over time.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a computing device, a server, and a device authentication server that cooperate to identify the device in accordance with one embodiment of the present invention.

FIG. 2 is a transaction flow diagram illustrating the manner in which the device is registered with the device authentication server for subsequent authentication.

FIG. 3 is a transaction flow diagram illustrating the manner in which the device, the server, and the device authentication server of FIG. 1 cooperate to authentication the device and the user of the device.

FIG. 4 is a block diagram of a known device record used by the device authentication server to authenticate the device.

FIG. 5 is a logic flow diagram of a hierarchical authentication process by which the device authentication server authenticates the device.

FIGS. 6 and 7 are each a logic flow diagram of an illustrative example of extraction logic by which a part of a dynamic device key (DDK) is generated.

FIGS. 8 and 9 are each a logic flow diagram of an illustrative example of comparison logic for comparison of corresponding attributes of DDKs.

FIGS. 10 and 11 are each a logic flow diagram of an illustrative example of adjustment logic for adjustments of attributes of the device once authenticated.

FIG. 12 is a block diagram showing in greater detail the server of FIG. 1.

FIG. 13 is a block diagram showing in greater detail the device authentication server of FIG. 1.

FIG. 14 is a block diagram showing in greater detail the personal computing device of FIG. 1.

### DETAILED DESCRIPTION

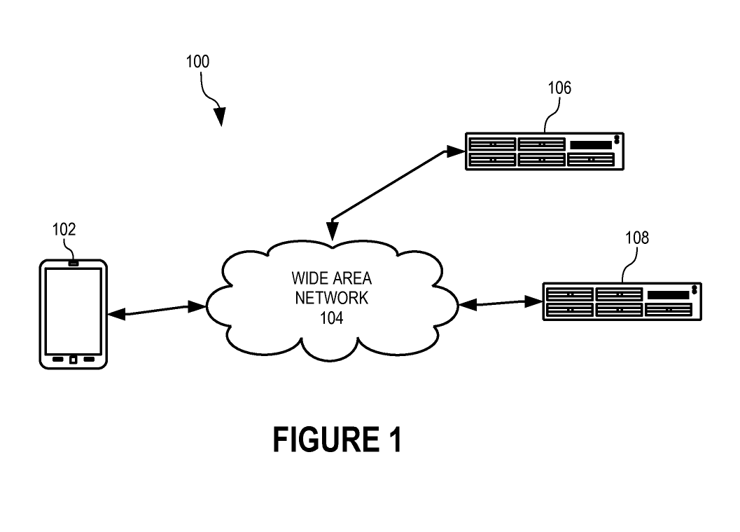

In accordance with the present invention, a device authentication server 108 (FIG. 1) authenticates a computing device 102 using a variety of types of hardware and system configuration attributes of device 102 and adapts the attributes to enable use of changing attributes for such authentication. In addition, authentication of device 102 is combined with authentication of the user of device 102.

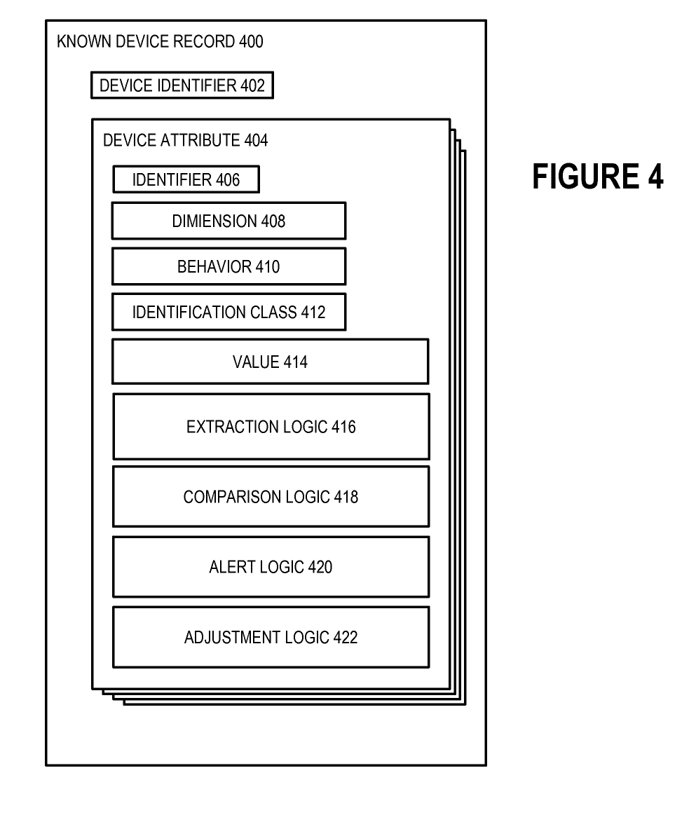

Device attributes are described briefly to facilitate understanding and appreciation of the present invention. Known device record 400 (FIG. 4) includes device attributes 404, both of which are described in greater detail below. Each device attribute 404 includes an identifier 406 and a value 414. Examples of device attributes of device 102 include a serial number of a storage device within device 102 and detailed version information regarding an operating system executing within device 102. In the example of a serial number of a storage device, identifier 406 specifies the serial number of a given storage device (such as “C:” or “/dev/sda1”) as the particular information to be stored as value 414, and value 414 stores the serial number of the given storage device of device 102.

Device authentication system 100 includes device 102, a server 106, and device authentication server 108 that are connected to one another through a wide area computer network 104, which is the Internet in this illustrative embodiment. Device 102 can be any of a number of types of networked computing devices, including smart phones, tablets, netbook computers, laptop computers, and desktop computers. Server 106 is a server that provides services to remotely located devices such as device 102 but that is configured to require authentication of device 102 prior to providing those services. Device authentication server 108 is a server that authenticates devices, sometimes on behalf of other computers such as server 106.

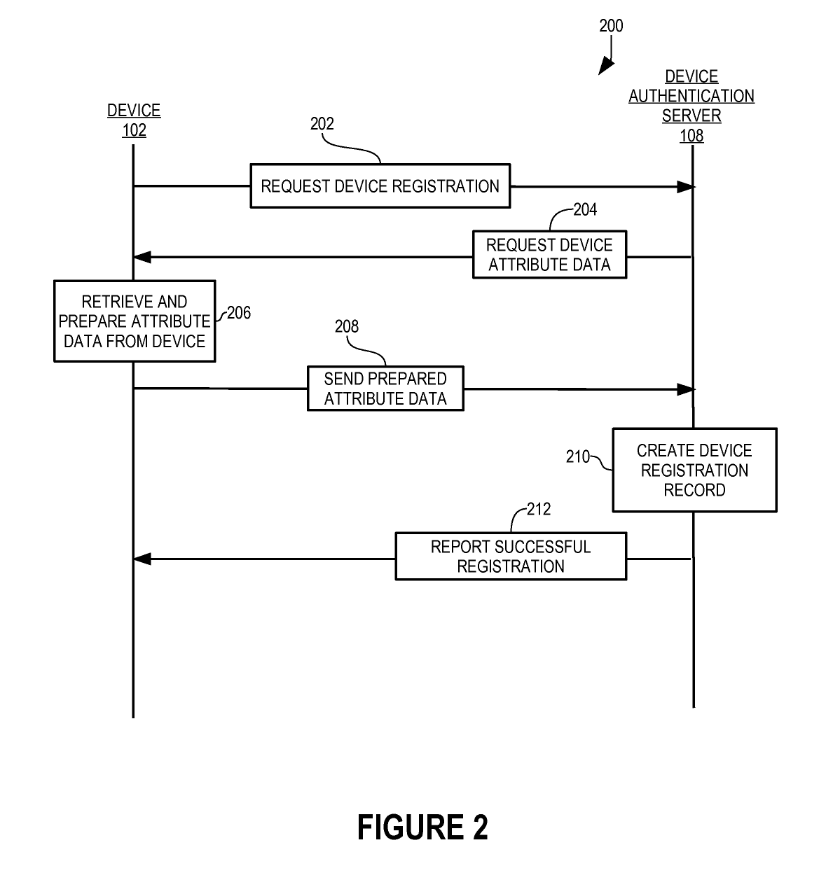

Transaction flow diagram 200 (FIG. 2) represents the manner in which device 102 registers itself with device authentication server 108 such that device 102 can subsequently be authenticated.

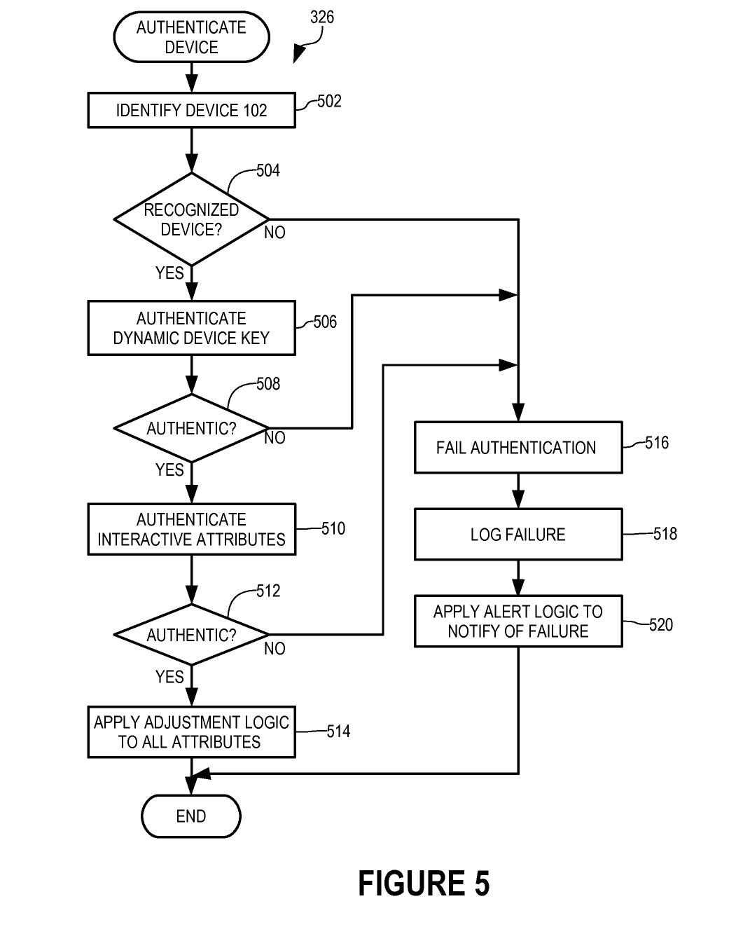

In step 202, device 102 sends a request for registration to device authentication server 108. The request can be in the form of a URL specified by the user of device 102 using a web browser 1420 (FIG. 5) executing in device 102 and conventional user interface techniques involving physical manipulation of user input devices 508. Web browser 1420 and user input devices 508 and other components of device 102 are described in greater detail below.

In step 204 (FIG. 2), device authentication server 108 sends a request to device 102 for device attributes of device 102.

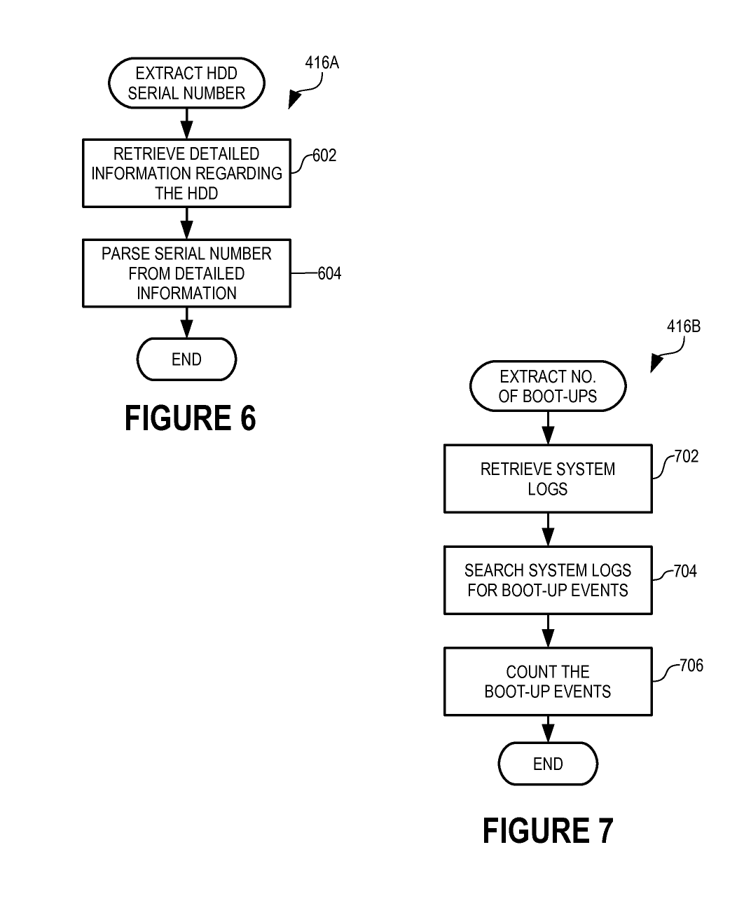

The request sent to device 102 includes content that causes web browser 620 (FIG. 6) of device 102 to gather attribute data representing hardware and other configuration attributes of device 102. In one embodiment, a web browser plug-in 622 is installed in device 102 and, invoked by web browser 620, processes the content of the web page to gather the attribute data in step 206. In other embodiments, the attribute data can be gathered by other forms of logic of device 102, such as DDK generator 1440 installed in device 102. In other embodiments, and in any embodiment described herein, the attribute data gathered from device 102 may include synthetic device attributes generated according to techniques disclosed in U.S. Provisional Application 61/682,096. For example, synthetic device attributes may be generated by device 102 according to a formula provided by device authentication server 108. The various elements of device 102 and their interaction are described more completely below.

The content that causes web browser 620 (FIG. 6) of device 102 to gather attribute data representing hardware and other configuration attributes of device 102 includes extraction logic 416 (FIG. 4) for each of the attributes web browser 620 (FIG. 6) is to gather. In an alternative embodiment, DDK generator 1440 already includes extraction logic for all attributes and device 102 receives data identifying the particular attributes requested by device authentication server 108. Extraction logic 416 (FIG. 4) defines the manner in which a client device is to extract data to be stored as value 414 of device attribute 404.

In this illustrative embodiment, web browser plug-in 622 (FIG. 6) or DDK generator 1440 encrypts the attribute data using a public key of device authentication server 108 and public key infrastructure (PKI).

In step 208 (FIG. 2), device 102 sends the attribute data that was gathered in step 206 to device authentication server 108.

In step 210, device authentication logic 1320 (FIG. 5) of device authentication server 108 creates a device registration record for device 102 from the received attribute data.

Known device record 400 (FIG. 4) is a registration record and, in this illustrative example, represents registration of device 102. Known device record 400 includes a device identifier 402 and a number of device attributes 404 which are described briefly above. Each device attribute 404 includes an identifier 406 specifying a particular type of information and a value 414 representing the particular value of that type of information from device 102. For example, if identifier 406 specifies a serial number of a given storage device, value 414 stores the serial number of that storage device within device 102.

Device attribute 404 also includes a dimension 408, a behavior 410, an identification class 412, extraction logic 416, comparison logic 418, alert logic 420, and adjustment logic 422. The particular device attribute represented by device attribute 404 is sometimes referred to as “the subject device attribute” in the context of FIG. 4.

Dimension 408 specifies the dimension of the subject attribute. In this illustrative embodiment, there are three (3) dimensions of device attributes: physical, environmental, and interactive.

Physical device attributes are those regarding physical hardware components of the device. Physical device attributes are typically associated with the hardware of the device as manufactured but can also be associated with peripheral devices and devices added after manufacture of the device.

Environmental device attributes are attributes of the usage state of the device, such as software components that have been installed in the device or data resulting from usage of the device.

Interactive device attributes are really attributes of the user of the device in that the user enters the value of such attributes interactively, e.g., using conventional user interface techniques.

Behavior 410 specifies the behavior of the subject device attribute, particularly the manner in which the subject device attribute changes over time. In this illustrative embodiment, there are six (6) types of behavior 410: constant, intermittent, variable, variable-progressive, variable-regressive, and variable-requisite.

Device attributes of the constant behavior type do not change. A mismatch in a constant device attribute results in a mismatch of a device with known device record 400. A CPU serial number can be a device attribute of the constant behavior type. Replacement of the CPU of a device can result in determination that the device is a different device than it was prior to the replacement. In some embodiments, attributes of other infrequently replaced hardware components of a device are of the constant behavior type. Examples include hard disk drives, RAM, and components integrated into the mother board of the device.

Device attributes of the intermittent behavior type are not always available and are typically associated with removable peripheral devices, such as external hard drives, cameras, scanners, printers, and other external peripheral devices.

Device attributes of the variable behavior type can change over time. Examples of device attributes of the variable behavior type can include many environmental device attributes, such as fonts installed on the device.

Device attributes of the variable-progressive behavior type can only increase over time. Examples of device attributes of the variable-progressive behavior type can include physical attributes such as a number of bad blocks or surface errors on a hard disk drive, environmental attributes such as the number of times a software application has been used, and interactive attributes such as the age of the user.

Device attributes of the variable-regressive behavior type can only decrease over time. Examples of device attributes of the variable-regressive behavior type can include the total storage capacity of a hard drive excluding bad blocks and a number of licenses remaining for a software application.

Device attributes of the variable-requisite behavior type must change between instance of authentication. In other words, a device attribute of the variable-requisite behavior type must have changed since the last time the device was authenticated. In one embodiment, a variable-requisite attribute need only be different from its value at the most recent authentication. In an alternative embodiment, a variable-requisite attribute must be different from its value in all previous authentications. Examples of device attributes of the variable-requisite behavior type can include the current time, the precise position of heads of a disk drive, or a pseudo-random number. Use of variable-requisite attributes in authentication of a device makes it more difficult for another device to spoof being device 102 by using previously intercepted attribute data. Failure to change a variable-requisite attribute by the other device results if failure of authentication.

Identification class 412 specifies a degree to which the subject device attribute identifies a device. In this illustrative embodiment, there are four (4) identification classes: unique, device-common, platform-common, and common.

Unique device attributes are globally unique and therefore are strong identifiers of a device. For example, the combination of the manufacturer, model, and serial number of most peripheral devices, such as hard disk drives, is unique among all peripheral devices and therefore unique among all computing devices in which they are installed.

Device-common device attributes are common to a particular type of device, such as an iPhone 4S for example, and are otherwise unique. Accordingly, device-common attributes can identify a particular type of device but cannot identify an individual device without additional attribute information.

Platform-common device attributes are common to a particular device platform. A device platform includes a particular operating system and can include a general device hardware architecture. Examples of device platforms include the Windows 7 operating system of Microsoft Corp running on an AMD 64-bit CPU architecture, Windows 7 running on an Intel Pentium series CPU architecture, the MacOS X 10.6 operating system of Apple Computer running on either architecture, many variants of the Linux operating system running on either architecture, the IOS operating system of Apple Computer, and the Android operating system of Google, Inc.

Common device attributes are common across multiple device types and platforms. One example of common device attributes are interactive device attributes.

Extraction logic 416 specifies the manner in which the subject device attribute is extracted by device 102. Examples of extraction logic 416 are described below.

Comparison logic 418 specifies the manner in which the subject device attribute is compared to a corresponding device attribute to determine whether device attributes match one another. Examples of comparison logic 418 are described below.

Alert logic 420 can specify alerts of device matches or mismatches or other events.

Adjustment logic 422 specifies the manner in which the subject device attribute is to be adjusted after authentication. For example, one way to properly authenticate variable-progressive device attributes, i.e., to ensure that the value only increases over time, is to record the highest value previously seen for the device attribute. Similarly, adjustment logic 422 can record the lowest value previously seen for variable-regressive device attributes and all values previously seen or just the last seen value for variable-requisite device attributes.

Device attribute 404 is shown to include the elements previously described for ease of description and illustration. However, it should be appreciated that a device attribute 404 for a given device can include only identifier 406 and value 414, while a separate device attribute specification can include dimension 408, behavior 410, identification class 412, extraction logic 416, comparison logic 418, alert logic 420, and adjustment logic 422. In addition, all or part of extraction logic 416, comparison logic 418, alert logic 420, and adjustment logic 422 can be common to attributes of a given dimension, behavior type, or identification class and can therefore be defined for the given dimension, behavior type, or identification class. For example, all interactive device attributes that are text to be entered by the user can share the same extraction logic 416 and comparison logic 418, only differing in the text prompt to be displayed to the user and the format of an acceptable answer (e.g., date, numerical, textual).

In addition, it should be appreciated that interactive attributes identify a user of device 102 and not device 102 itself. For simplicity and clarity of explanation, known device record 404 includes both interactive and non-interactive attributes, representing a one-to-one relationship between a user and a device. In some embodiments, interactive attributes can be stored in a known user record and one or more known device records can be associated with the known user record in known device data 1330.

Returning to step 210 (FIG. 2), device authentication server 108 creates a device registration record for device 102 by creating a globally unique identifier for device 102 as device identifier 402 (FIG. 4) and storing the values of the respective attributes received in step 208 (FIG. 2) as value 414 (FIG. 4) in respective device attributes 404.

In step 212 (FIG. 2), device authentication server 108 sends a report of successful registration to device 102. After step 212 (FIG. 2), processing according to transaction flow diagram 200 completes and device 102 is registered for subsequent authentication with device authentication server 108.

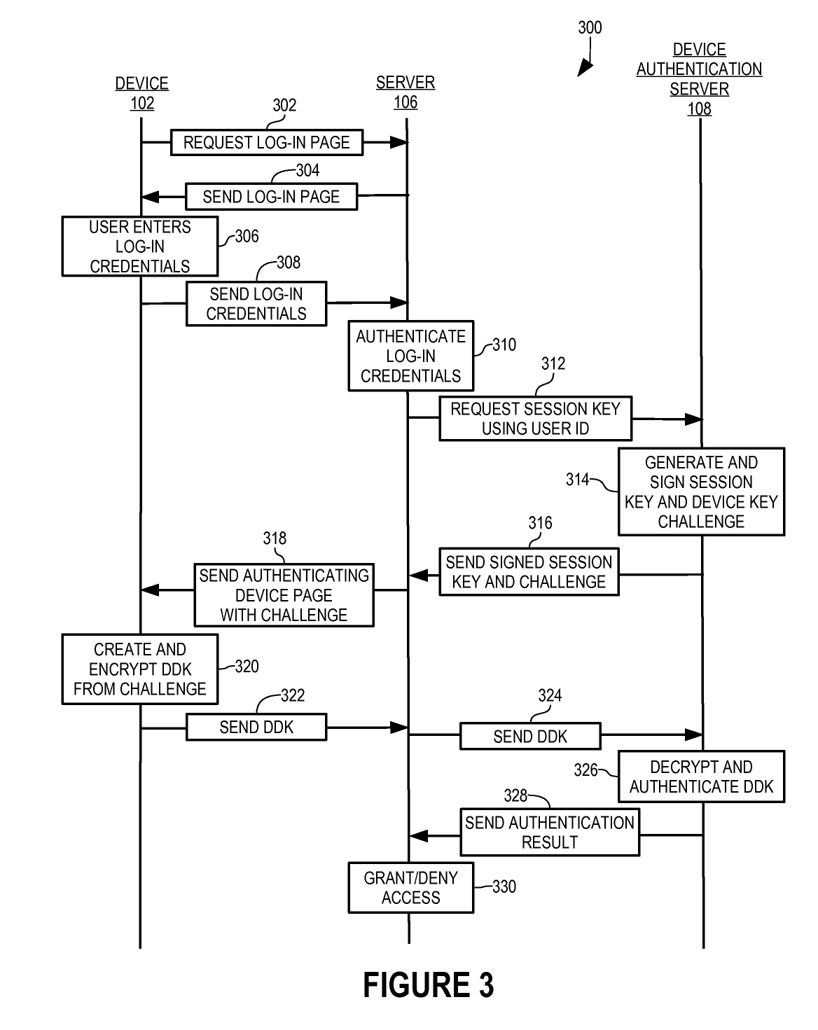

Transaction flow diagram 300 (FIG. 3) illustrates the use of device authentication server 108 to authenticate a user of device 102 and device 102 itself with server 106.

In step 302, device 102 sends a request for a log-in web page to server 106 by which the user can authenticate herself. The request can be in the form of a URL specified by the user of device 102 using web browser 620 (FIG. 6) and conventional user interface techniques involving physical manipulation of user input devices 608.

In step 304 (FIG. 3), server 106 sends the web page that is identified by the request received in step 302. The web page sent to device 102 includes content that defines a user interface by which the user of device 102 can enter her authentication credentials, such as a user name and associated password for example.

In step 306, web browser 620 (FIG. 6) of device 102 executes the user interface and the user of device 102 enters her authentication credentials, e.g., by conventional user interface techniques involving physical manipulation of user input devices 608.

In step 308 (FIG. 3), device 102 sends the entered authentication credentials to server 106. Server 106 authenticates the authentication credentials in step 310, e.g., by comparison to previously registered credentials of known users. If the credentials are not authenticated, processing according to transaction flow diagram 300 terminates and the user of device 102 is denied access to services provided by server 106. Conversely, if server 106 determines that the received credentials are authentic, processing according to transaction flow diagram 300 continues.

In step 312 (FIG. 3), server 106 sends a request to device authentication server 108 for a session key using a user identifier from the received authentication credentials. In embodiments in which each user has at most one associated device, the user identifier also identifies device 102. In alternative embodiments, the request can include data identifying device 102 as well.

In response to the request, device authentication server 108 generates and cryptographically signs a session key. Session keys and their generation are known and are not described herein. In addition, device authentication server 108 creates a device key challenge and encrypts the device key challenge using a public key of device 102 and PKI. In step 316, device authentication server 108 sends the signed session key and the encrypted device key challenge to server 106.

In step 318, server 106 sends a “device authenticating” page to device 102 along with the device key challenge. The “device authenticating” page includes content that provides a message to the user of device 102 that authentication of device 102 is underway.

The device key challenge causes web browser 620 (FIG. 6) of device 102 to generate a device identifier, sometimes referred to herein as a dynamic device key (DDK) for device 102, e.g., dynamic device key 1442. In one embodiment, a web browser plug-in 622 is installed in client device 102 and, invoked by web browser 620, processes the content of the web page to generate the DDK. In other embodiments, DDK 1442 of device 102 can be generated by other forms of logic of device 102, such as DDK generator 1440, which is a software application installed in device 102.

The device key challenge specifies the manner in which DDK 1442 is to be generated from the attributes of device 102 represented in device attributes 404 (FIG. 4). The challenge specifies a randomized sampling of attributes of device 102, allowing the resulting DDK 1442 to change each time device 102 is authenticated. There are a few advantages to having DDK 1442 represent different samplings of the attributes of device 102. One is that any data captured in a prior authentication of device 102 cannot be used to spoof authentication of device 102 using a different device when the challenge has changed. Another is that, since only a small portion of the attributes of device 102 are used for authentication at any time, the full set of attributes of device 102 cannot be determined from one, a few, several, or even many authentications of device 102.

In particular, the device key challenge specifies items of information to be collected from hardware and system configuration attributes of device 102 and the manner in which those items of information are to be combined to form DDK 1442. The generation of a dynamic device key from a device key challenge is described in U.S. Patent Application Publication US 2011/0009092 and that description is incorporated herein.

In this embodiment, the challenge can not only specify a subset of attributes of device 102 to gather but can also specify that only a portion of each attribute is collected or that given attributes are obscured. For example, the challenge can specify that the 9^{th}, 5^{th}, and 17^{th} characters of the serial number of a specific hard disk drive be gathered. In addition, the challenge can specify that a numerical attribute, such as the number of times a given software application has been used, is to be divided by 13 and represented in scientific notation. Furthermore, the order of attribute portions included in DDK 1442 can vary, resulting in a different key, particularly if hashed.

It should also be noted that the challenge can specify one or more interactive attributes, requiring attribute data to be provided by the user. Some interactive attributes can require data entry by the user. Examples include a user name, associated password, and date and place of birth. Other interactive attributes can require that the user provide biometric data such as a fingerprint or a retina scan.

Once DDK 1442 is generated according to the received device key challenge, device 102 encrypts DDK 1442 using a public key of device authentication server 108 and PKI.

In step 322 (FIG. 3), device 102 sends the encrypted dynamic device key to server 106, and server 106 sends the encrypted dynamic device key to device authentication server 108 in step 324.

In step 326, device authentication logic 1320 of device authentication server 108 decrypts and authenticates the received DDK. Step 326 is shown in greater detail as logic flow diagram 326 (FIG. 5).

In step 502, device authentication logic 1320 identifies device 102. In this illustrative embodiment, the received DDK includes a device identifier corresponding to device identifier 402 (FIG. 4). Device authentication logic 1320 identifies device 102 by locating a known device record 400 in which device identifier 402 matches the device identifier of the received DDK.

In test step 504 (FIG. 5), device authentication logic 1320 determines whether device 102 is identified. In particular, device authentication logic 1320 determines whether a known device record with a device identifier matching the device identifier of the received DDK is successfully found in known device data 1330. If so, processing transfers to step 506. Otherwise, processing transfers to step 516, which is described below.

In step 506, device authentication logic 1320 authenticates the received DDK using the known device record 400 (FIG. 4) for the identified device, e.g., device 102. Device authentication logic 1320 authenticates by applying the same device key challenge sent in step 318 (FIG. 3) to the known device record 400 that corresponds to the identified device. In this illustrative embodiment, the device key challenge produces a DDK in which a portion of the DDK generated from non-interactive attributes can be parsed from a portion generated from interactive attributes, such that device 102 can be authenticated separately from the user of device 102.

In test step 508, device authentication logic 1320 determines whether the received DDK authenticates device 102 by comparing the resulting DDK of step 506 to the received DDK, at least the portion of the DDKs not generated from interactive attributes. In this illustrative embodiment, device authentication logic 1320 uses comparison logic 418 (FIG. 4) for each of the device attributes 404 included in the device key challenge with a dimension 408 that does not indicate an interactive attribute. Examples of comparison logic 418 are described below.

If the received DDK does not authenticate device 102, processing transfers to step 516 and authentication fails or, alternatively, to step 314 (FIG. 3) in which device authentication logic 1320 sends another device key challenge to re-attempt authentication. If the received DDK authenticates device 102, processing transfers to step 510.

In step 510, device authentication logic 1320 authenticates the portion of the received DDK generated from interactive attributes using the known device record 400 (FIG. 4) for the identified device, e.g., device 102. Device authentication logic 1320 authenticates by applying the same device key challenge sent in step 318 (FIG. 3) to the known device record 400 that corresponds to the identified device.

In test step 512, device authentication logic 1320 determines whether the received DDK authenticates the user of device 102 by comparing the resulting DDK of step 506 to the received DDK, at least the portion of the DDKs generated from interactive attributes in the manner described above with respect to non-interactive attributes. If not, processing transfers to step 516 and authentication fails or, alternatively, to step 314 (FIG. 3) in which device authentication logic 1320 sends another device key challenge to re-attempt authentication. If the received DDK authenticates the user of device 102, processing transfers to step 514.

In step 514, device authentication logic 1320 applies adjustment logic to the attributes used to generate the received DDK. In particular, device authentication logic 1320 applies adjustment logic 422 (FIG. 4) of each of device attributes 404 uses to generate the received DDK.

After step 514, device 102 and the user of device 102 are successfully authenticated and processing according to logic flow diagram 326, and therefore step 326, completes. As described above, authentication failure at any of test steps 504, 508, and 512 transfers processing to step 516.

In step 516, device authentication logic 1320 determines that device 102 or the user thereof are not authentic, i.e., that authentication according to logic flow diagram 326 fails.

In step 518, device authentication logic 1320 logs the failed authentication and, in step 520, applies alert logic 420 (FIG. 4) to notify various entities of the failed authentication. After step 520, processing according to logic flow diagram 326, and therefore step 326, completes.

In step 328 (FIG. 3), device authentication server 108 sends data representing the result of authentication of device 102 to server 106.

In step 330, server 106 determines whether to continue to interact with device 102 and in what manner according to the device authentication results received in step 328.

As described above, the particular manner in which device extracts the data representing a given attribute depends on the particular details of extraction logic 416 defined for that attribute. Logic flow diagram 416A (FIG. 6) is an illustrative example of extraction logic for data regarding a hardware characteristic of device 102.

In step 602, web browser plug-in 1422 retrieves detailed information about a hard disk drive of device 102. For example, in an embodiment in which device 102 includes the known Linux operating system, web browser plug-in 1422 can retrieve detailed information about a hard disk drive by executing the command, “hdparm-I/dev/sda”. To enhance efficiency, web browser plug-in 1422 can cache the results of that command to extract data for other elements related to detailed information about the hard disk drive.

In step 604, web browser plug-in 1422 parses the serial number of the hard disk drive from the detailed information retrieved in step 602. Parsing of the serial number is a straight forward process of pattern recognition, using regular expressions for example.

Logic flow diagram 416B (FIG. 7) is an illustrative example of extraction logic for data regarding a number of times device 102 has been booted up. This attribute has a variable-progressive behavior type since the number of times a given device is booted only increases over time. In step 702, web browser plug-in 1422 retrieves system log files from operating system 1130 (FIG. 11).

In step 704, web browser plug-in 1422 searches the system log files for boot-up events that indicate an instance of booting up of device 102.

In step 706, web browser plug-in 1422 counts the instances of booting up of device 102 found in step 704 to determine the number of times device 102 has been booted up.

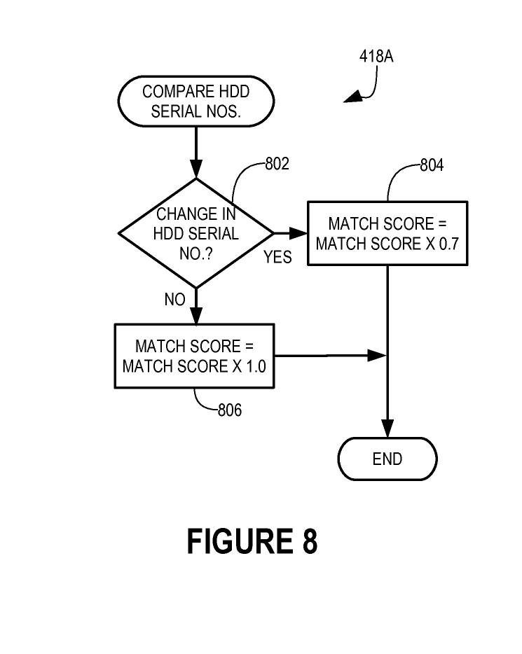

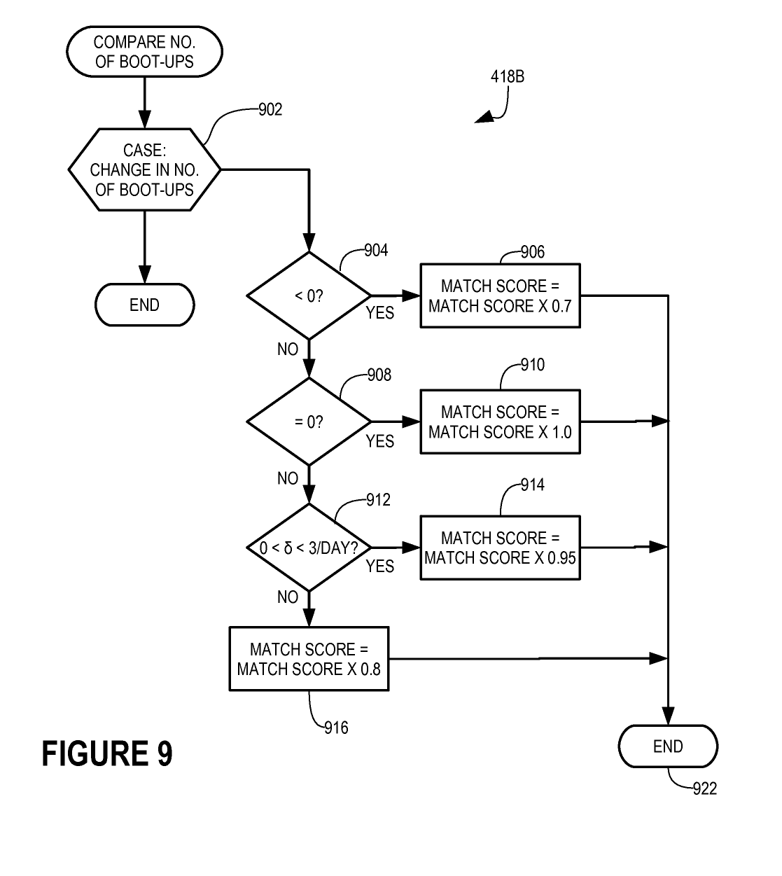

As described above, matches for each attribute are determined according to comparison logic 418 (FIG. 4) for the attribute. In this illustrative example, device authentication logic 1320 initializes a match score to 1.0 and adjusts the match score as each attribute is compared. Examples of comparison logic 418 are illustrated in logic flow diagrams 418A (FIG. 8) and 418B (FIG. 9).

Logic flow diagram 418A (FIG. 8) is an illustrative example of comparison logic for data regarding a hardware characteristic of device 102. In test step 802, device authentication logic 1320 compares data representing the serial number of a hard disk drive of the received DDK to data representing the serial number of a hard disk drive of the reference DDK. If the respective serial numbers are not the same, processing transfers to step 804 in which device authentication logic 1320 reduces the match score by 30%, by multiplication of the match score by 0.7, in step 804. Conversely, if the respective serial numbers are the same, device authentication logic 1320 does not reduce the match score in step 806. Step 806 shows that device authentication logic 1320 multiplies the match score by 1.0 only to explicitly show that the match score remains unchanged.

Thus, according to logic flow diagram 418A, a mismatch in the serial number of a hard disk drive suggests that the received DDK and the reference digital fingerprint do not represent one and the same device and the suggestion is reflected in the match score. Such suggestions accumulate as comparison logic for other attributes can further reduce or increase the match score.

Logic flow diagram 418B (FIG. 9) is an illustrative example of comparison logic for data regarding a variable-progressive attribute of device 102. In case step 902, device authentication logic 1320 evaluates a change in the number of times device 102 has been booted. Case step 902 directs processing by device authentication logic 1320 to one of steps 906, 910, 914, and 916 according to the test values of test steps 904, 908, and 912.

If the received DDK and the reference known device record show a reduction in the number of times device 102 has been booted up, processing by device authentication logic 1320 transfers through test step 904 to step 906 in which device authentication logic 1320 reduces the match score by 30%, by multiplication of the match score by 0.7. The reduction in the number of times device 102 has been booted up is strongly indicative of a mismatch between the received DDK and the reference known device record.

If the received DDK and the reference known device record show no change in the number of times device 102 has been booted over time over time, processing by device authentication logic 1320 transfers through test step 908 to step 910 in which device authentication logic 1320 does not reduce the match score at all. This embodiment naturally assumes device 102 has a very stable operating system.

If the received DDK and the reference known device record show an increase in the number of times device 102 has been booted up over time of no more than three (3) per day, processing by device authentication logic 1320 transfers through test step 912 to step 914 in which device authentication logic 1320 reduces the match score by 5%, by multiplication of the match score by 0.95.

If the received DDK and the reference known device record show an increase in the number of times device 102 is booted up over time of more than three (3) per day, processing by device authentication logic 1320 transfers through test step 912 to step 912 in which device authentication logic 1320 reduces the match score by 20%, by multiplication of the match score by 0.8.

Other thresholds and adjustments to the match score may be determined to more accurately indicative of a match in practice.

Thus, according to logic flow diagram 418B, a large mismatch in the number of times device 102 has been booted can suggest that the received DDK and the reference digital fingerprint do not represent one and the same device and the suggestion is reflected in the match score. The degree to which such is suggested depends upon how changes in the number follows an expected pattern.

After comparison logic 418 for all attributes of the received DDK have been processed, device authentication logic 1320 compares the cumulative match score to a predetermined threshold. If the cumulative match is at least the predetermined threshold, device authentication logic 1320 determines that device 102 is authentic. Conversely, if the cumulative match score is below the predetermined threshold, device authentication logic 1320 determines that device 102 is not authentic.

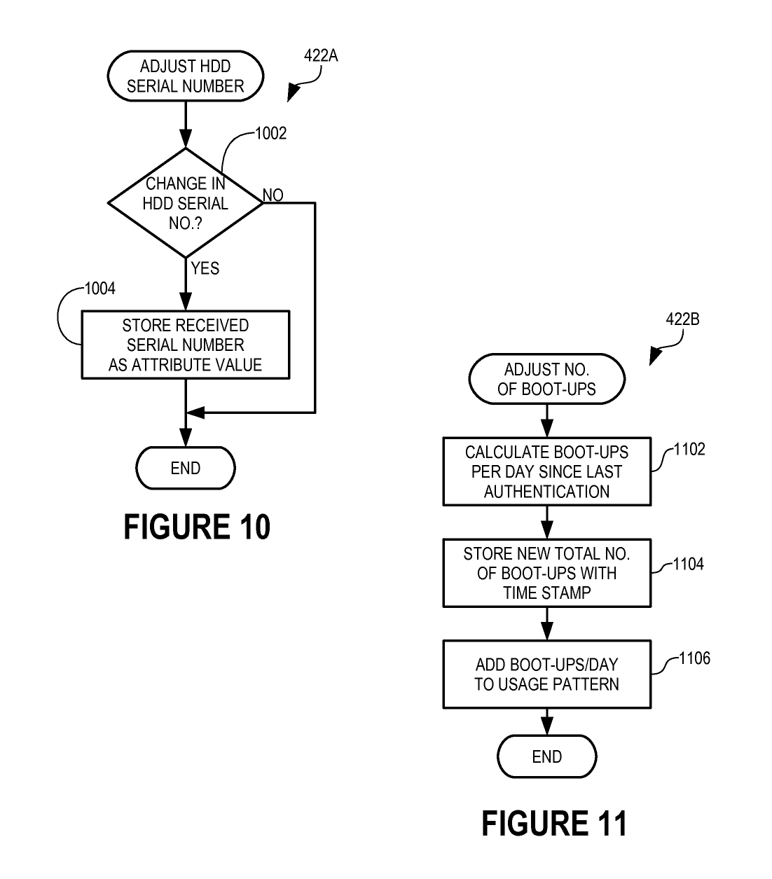

As described above with respect to test step 512 (FIG. 5), device authentication logic 1320 adjusts attributes of the received DDK using adjustment logic 422 of the respective attributes only if device 102 and the received DDK are determined to be authentic. Examples of adjustment logic 422 are illustrated in logic flow diagrams 422A (FIG. 10) and 422B (FIG. 11).

In test step 1002 (FIG. 10), device authentication logic 1320 determines whether the hard disk drive (HDD) serial number of the received DDK differs from the one in the known device record. Is should be remembered that device 102 and the received DDK have already been authenticated. Accordingly, a change in the serial number of the HDD serial number indicates that the HDD of device 102 has been replaced. Accordingly, if the HDD has changed, device authentication logic 1320 stores the new HDD serial number as the attribute value in step 1004. If the device key challenge specified that the received DDK included less then the entirety of the HDD serial number, device authentication logic 1320 can request the full HDD serial number from device 102. In this illustrative embodiment, all such requests for new attribute data from device 102 are collected and sent to device 102 together in a single transaction.

If the HDD serial number has not changed, device authentication logic 1320 skips step 1004. After steps 1002 and 1004, processing according to logic flow diagram 422A completes.

Logic flow diagram 422B (FIG. 11) shows adjustment by device authentication logic 1320 of an attribute representing the number of times device 102 has been booted up in this illustrative embodiment. In step 1102, device authentication logic 1320 calculates the rate of boot-ups of device 102 per day since the last authentication of device 102. In this illustrative embodiment, device authentication logic 1320 stores historical attribute values with associated time stamps in known device record 400 for device 102. Accordingly, device authentication logic 1320 can use patterns in the attribute history to adjust comparison logic 418B for better performance.

While the number of times device 102 has been booted up is variable-progressive, it is possible that this attribute will decrease between successful instances of authentication in some embodiments. For example, if operating system 1430 of device 102 is one that decays over time, with small, accumulating bugs that render device 102 nearly unusable over time, a common solution is to re-install operating system 1430. In such an instance, device authentication logic 1320 can treat the current instance of authentication of device 102 as the initial authentication, clearing the history of boot-up patterns for device 102. Alternatively, device authentication logic 1320 can assume that the last instance of authentication of device 102 immediately preceded the re-installation of operating system 1430, treating the number of boot-ups of device 102 in the received DDK as representing total number of boot-ups of device 102 during the time between the last and the current instances of authentication.

In step 1104, device authentication logic 1320 stores the new total of boot-ups of device 102 from the received DDK in the boot-up history in known device record 400. In step 1106, device authentication logic 1320 adds data representing the calculated number of boot-ups per day of device 102 since the last instance of authentication to the boot-up history. After step 1106, processing by device authentication logic 1320 accordingly to logic flow diagram 422B completes.

In some embodiments, device authentication server 108 coordinates authentication with other servers, such as server 106 for example. Accordingly, adjustment logic 422 for any attribute can include logic that causes device authentication logic 1320 to notify other servers of changes to attributes of device 102 as represented in known device record 400.

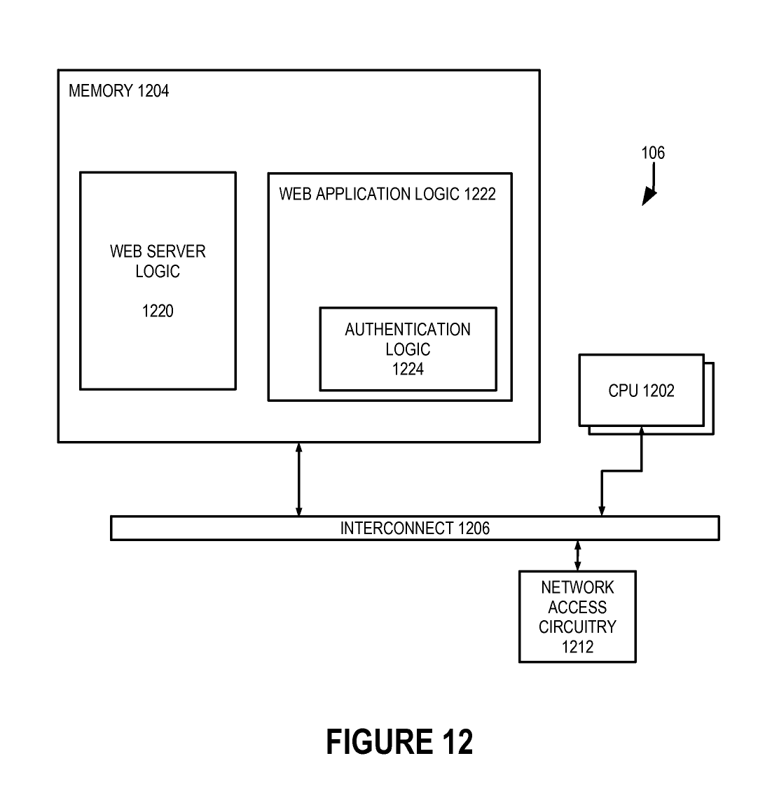

Server computer 106 is shown in greater detail in FIG. 12. Server 106 includes one or more microprocessors 1202 (collectively referred to as CPU 1202) that retrieve data and/or instructions from memory 1204 and execute retrieved instructions in a conventional manner. Memory 1204 can include generally any computer-readable medium including, for example, persistent memory such as magnetic and/or optical disks, ROM, and PROM and volatile memory such as RAM.

CPU 1202 and memory 1204 are connected to one another through a conventional interconnect 1206, which is a bus in this illustrative embodiment and which connects CPU 1202 and memory 1204 to network access circuitry 1212. Network access circuitry 1212 sends and receives data through computer networks such as wide area network 104 (FIG. 1).

A number of components of server 106 are stored in memory 1204. In particular, web server logic 1220 and web application logic 1222, including authentication logic 1224, are all or part of one or more computer processes executing within CPU 1202 from memory 1204 in this illustrative embodiment but can also be implemented using digital logic circuitry.

Web server logic 1220 is a conventional web server. Web application logic 1222 is content that defines one or more pages of a web site and is served by web server logic 1220 to client devices such as device 102. Authentication logic 1224 is a part of web application logic 1222 that causes client devices and their users to authenticate themselves in the manner described above.

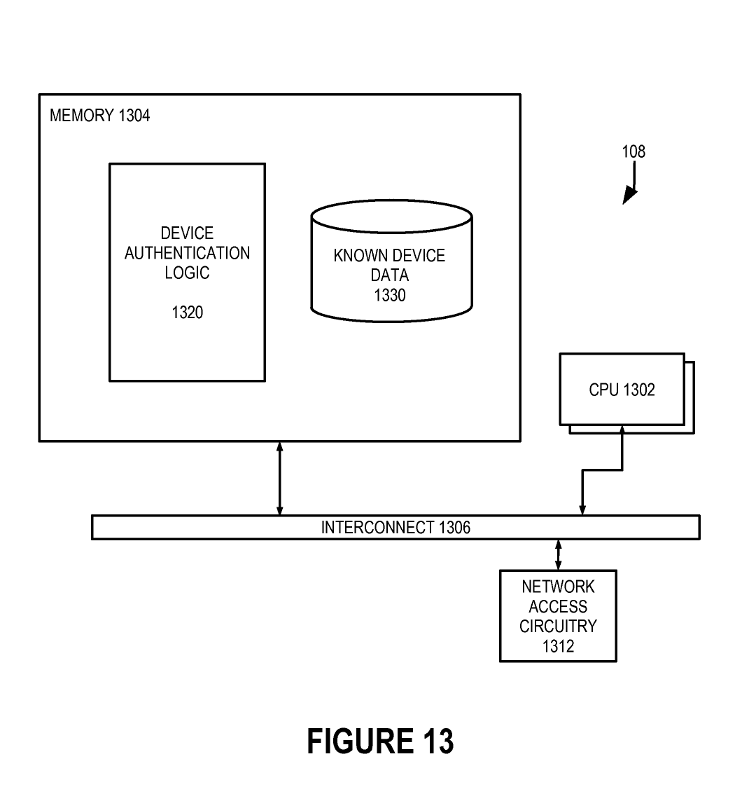

Device authentication server 108 is shown in greater detail in FIG. 13. Device authentication server 108 includes one or more microprocessors 1302 (collectively referred to as CPU 1302), memory 1304, a conventional interconnect 1306, and network access circuitry 1312, which are directly analogous to CPU 1202 (FIG. 12), memory 1204, conventional interconnect 1206, and network access circuitry 1212, respectively.

A number of components of device authentication server 108 (FIG. 13) are stored in memory 1304. In particular, device authentication logic 1320 is all or part of one or more computer processes executing within CPU 1302 from memory 1304 in this illustrative embodiment but can also be implemented using digital logic circuitry. Known device data 1330 is data stored persistently in memory 1304. In this illustrative embodiment, known device data 1330 is organized as all or part of one or more databases.

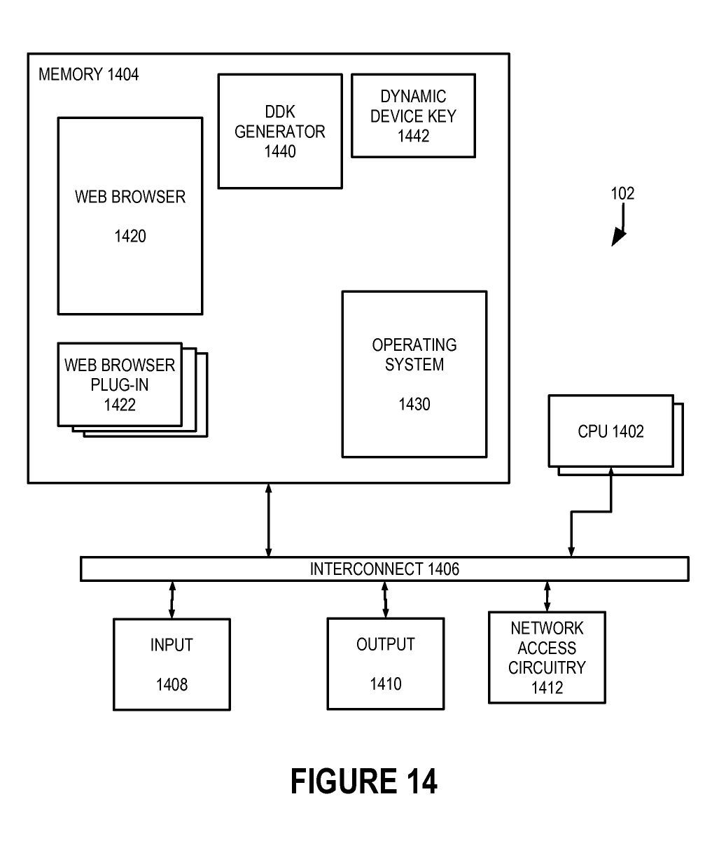

Device 102 is a personal computing device and is shown in greater detail in FIG. 14. Device 102 includes one or more microprocessors 1402 (collectively referred to as CPU 1402) that retrieve data and/or instructions from memory 1404 and execute retrieved instructions in a conventional manner. Memory 1404 can include generally any computer-readable medium including, for example, persistent memory such as magnetic and/or optical disks, ROM, and PROM and volatile memory such as RAM.

CPU 1402 and memory 1404 are connected to one another through a conventional interconnect 1406, which is a bus in this illustrative embodiment and which connects CPU 1402 and memory 1404 to one or more input devices 1408, output devices 1410, and network access circuitry 1412. Input devices 1408 can include, for example, a keyboard, a keypad, a touch-sensitive screen, a mouse, a microphone, and one or more cameras. Output devices 1410 can include, for example, a display—such as a liquid crystal display (LCD)—and one or more loudspeakers. Network access circuitry 1412 sends and receives data through computer networks such as wide area network 104 (FIG. 1).

A number of components of device 102 are stored in memory 1404. In particular, web browser 1420 is all or part of one or more computer processes executing within CPU 1402 from memory 1404 in this illustrative embodiment but can also be implemented using digital logic circuitry. As used herein, “logic” refers to (i) logic implemented as computer instructions and/or data within one or more computer processes and/or (ii) logic implemented in electronic circuitry. Web browser plug-ins 1422 are each all or part of one or more computer processes that cooperate with web browser 1420 to augment the behavior of web browser 1420. The manner in which behavior of a web browser is augmented by web browser plug-ins is conventional and known and is not described herein.

Operating system 1430 is all or part of one or more computer processes executing within CPU 1402 from memory 1404 in this illustrative embodiment but can also be implemented using digital logic circuitry. An operating system (OS) is a set of programs that manage computer hardware resources and provide common services for application software such as web browser 1420, web browser plug-ins 1422, and DDK generator 1440.

DDK generator 1440 is all or part of one or more computer processes executing within CPU 1402 from memory 1404 in this illustrative embodiment but can also be implemented using digital logic circuitry. DDK generator 1440 facilitates authentication of device 102 in the manner described above.

Dynamic device key 1442 is data stored persistently in memory 1404 and can be organized as all or part of one or more databases.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for identifying a remotely located device, the method comprising:
receiving device identification data from the device, wherein the device identification data includes:
a device identifier, wherein the device identifier is a unique identifier of one of a number of known devices;
attribute data, wherein the attribute data represents one or more hardware configuration characteristics of the device; and
interactive attribute data, wherein the interactive attribute data represents one or more characteristics of a user of the device;
determining that the device identifier identifies the device;
in response to determining that the device identifier identifies the device, determining that the attribute data is consistent with corresponding reference attribute data stored for the device;
in response to determining that the attribute data is consistent with corresponding reference attribute data stored for the device, determining that the interactive attribute data is consistent with corresponding reference interactive attribute data stored for the user of the device; and
in response to determining that the interactive attribute data is consistent with corresponding reference interactive attribute data stored for the user of the device, adjusting one or more attributes represented in a group consisting essentially of the reference attribute data and the reference interactive attribute data using predetermined attribute adjustment logic.

2. The method of claim 1 wherein determining that the attribute data is consistent with corresponding reference attribute data stored for the device comprises:
determining that the attribute data is not consistent with the corresponding reference attribute data stored for the device; and
in response to determining that the attribute data is not consistent with the corresponding reference attribute data stored for the device, requesting new device identification data from the device and, in response to the request, repeating the receiving of device identification data from the device.

3. The method of claim 2 wherein determining that the interactive attribute data is consistent with corresponding reference interactive attribute data stored for the device comprises:
determining that the interactive attribute data is not consistent with the corresponding reference interactive attribute data stored for the device; and
in response to determining that the interactive attribute data is not consistent with corresponding reference interactive attribute data stored for the device, requesting new device identification data from the device and, in response to the request, repeating the receiving of device identification data from the device.

4. The method of claim 1 wherein determining that the interactive attribute data is consistent with corresponding reference interactive attribute data stored for the device comprises:
determining that the interactive attribute data is not consistent with the corresponding reference interactive attribute data stored for the device; and
in response to determining that the interactive attribute data is not consistent with corresponding reference interactive attribute data stored for the device, requesting new device identification data from the device and, in response to the request, repeating the receiving of device identification data from the device.

5. The method of claim 1 wherein determining that the attribute data is consistent with corresponding reference attribute data stored for the device comprises:
applying predetermined comparison logic associated with the attribute data.

6. The method of claim 1 wherein determining that the attribute data is consistent with corresponding reference attribute data stored for the device comprises:
applying predetermined comparison logic associated with the interactive attribute data.
